(19) United States
(12) Patent Application Publication
(10) Pub. No.: US 2003/0067464 A1
(43) Pub. Date: Apr. 10, 2003

(54) System for displaying personal messages at a public facility and method of doing business

(75) Inventors: Laurie E. Gathman, East Norwich, NY (US); Jack E. Haken, Danbury, CT (US)

Correspondence Address: Corporate Patent Counsel, Philips Electronics North America Corporation, 580 White Plains Road, Tarrytown, NY, 10591, US

(73) Assignee: KONINKLIJKE PHILIPS ELECTRONICS N.V.

(21) Appl. No.: 09/971,229

(22) Filed: Oct. 4, 2001

(51) Int. Cl. G06T 11/20

(52) U.S. Cl. 345/440

(57) ABSTRACT

A messaging system for displaying personal messages on the displays of a public facility. The messaging system comprises: 1) a plurality of access points capable of communicating with a plurality of customer communication devices operated by customers of the public facility; 2) a personal message controller coupled to the plurality of access points and capable of receiving a first personal message from a first one of the customer communication devices; and 3) a display control system coupled to the personal message controller and capable of receiving from the personal message controller a first display control message associated with the first personal message, wherein the first control message is operable to cause the display control system to display the first personal message on at least one of the displays of the public facility.

### CROSS-REFERENCE TO RELATED APPLICATIONS

The present invention is related to those disclosed in the following United States Patent Applications:

1. Ser. No. [Docket No. US 010493], filed concurrently herewith, entitled “SELLING BEST AVAILABLE SEATS AT A PUBLIC FACILITY”;

2. Ser. No. [Docket No. US 010495], filed concurrently herewith, entitled “SYSTEM AND BUSINESS METHOD FOR OFFERING SEAT UPGRADES TO PATRONS AT A PUBLIC FACILITY”;

3. Serial No. [Docket No. US 010496], filed concurrently herewith, entitled “BUSINESS METHOD AND SYSTEM FOR COMMUNICATING PUBLIC-FACILITY STATUS INFORMATION THROUGH A VIRTUAL TICKET DEVICE”;

4. Ser. No. [Docket No. US 010497), filed concurrently herewith, entitled “TICKET EXCHANGE SYSTEM AND METHOD OF OPERATION”;

5. Ser. No. [Docket No. US 010498], filed concurrently herewith, entitled “PUBLIC VENUE AUCTION SYSTEM AND METHOD OF OPERATION”;

6. Ser. No. [Docket No. US 010499], filed concurrently herewith, entitled “SYSTEM AND METHOD FOR SELLING GOODS TO CUSTOMERS OF A PUBLIC FACILITY”; and

7. Ser. No. [Docket No. US 010500], filed concurrently herewith, entitled “SYSTEM AND METHOD FOR SELLING IMAGE DISPLAY TIME TO CUSTOMERS OF A PUBLIC FACILITY”.

The above applications are commonly assigned to the assignee of the present invention. The disclosures of these related patent applications are hereby incorporated by reference for all purposes as if fully set forth herein.

### TECHNICAL FIELD OF THE INVENTION

The present invention is directed to display control systems and, more specifically, to a system and method for displaying personal messages received from customers at a large public venue.

### BACKGROUND OF THE INVENTION

Large public entertainment facilities, such as convention centers, concert halls, stadiums, sports arenas, and the like, are the civic centers of many communities and are important sources of revenue and employment. Quite often, public facilities are funded by taxpayers in order to attract or at least retain sports franchises, and to attract tourists and conventions. The large sums invested in public entertainment facilities make it essential to maximize the revenue derived from such facilities and to minimize their operating costs.

However, large public facilities tend to be labor intensive operations. A typical sports facility requires a large number of gate attendants, ticket agents, ushers, concession stand operators, shop vendors, and security officers, and the like. Many new sports facilities also employ waiters and waitresses who take orders from, and serve food and drink to, customers at their seats. Facility operators use labor-saving technology wherever possible in order to offset the high labor costs associated with large public facilities.

In addition to cutting costs, facility operators also try to increase revenue in different ways. The principle sources of revenue are ticket sales, concession stands, and vendor shops. Promotions are frequently offered in order to increase sales and many public facilities do not permit patrons to bring their own food and drink into the venues. And facility operators are increasingly seeking new technology to provide new and enjoyable services to customers and thereby increase attendance and revenue.

There is therefore a need in the art for technical improvements that reduce the costs of operating large public entertainment facilities. In particular, there is a need for new technologies that help to reduce labor costs associated with a operating large public facilities. Additionally, there is a need for technical improvements that enhance the revenues of large public facilities. More particularly, there is a need for new technologies that provide useful and enjoyable services to the patrons of large public facilities.

### SUMMARY OF THE INVENTION

To address the above-discussed deficiencies of the prior art, there is provided a portable computer system (hereafter a “virtual ticket device”) that delivers virtual tickets for sports events, theater, concerts, and the like, together with various services and methods of doing business which are linked to and implemented through the virtual ticket device.

In its simplest form, the virtual ticket device is an existing smart telephone or cellular communication-enabled personal digital assistant (PDA), such as a PALM PILOT™ or a VISOR™ electronic organizer, a portable video game controller or a portable personal computer. A dedicated virtual ticket device could also be used. A customer who wishes to attend an event purchases admission in any conventional manner (e.g., by telephone from a ticket service, in person at a box office, via the Internet). The ticket vendor sends an encrypted admission authorization record over a wireless channel or a wireline channel to the virtual ticket device, where it is stored as a virtual electronic ticket.

It will be recognized that the virtual ticket device serves multiple functions to its user. There are clear synergies between many of these functions; for example the communications functions of the device may be enhanced when the customers seat location and entry time are known and stored in the system. Nevertheless many aspects of the present invention remain new and useful even when the customer is admitted to the facility with a paper ticket or in another conventional manner and for this reason, the term “virtual ticket device” as used in this patent specification and the claims which follow, is not limited or restricted to a device which is actually used or even programmed to authorize a customer's admission to the facility.

The encrypted admission authorization record may include, for example, information which identifies the date and location of the event, the seat number, price paid, and the like. The encrypted admission authorization record also may include uniquely encrypted information which may be used in a conventional manner to authenticate that the record is genuine. The same information is preferably stored in a central database which is accessible by the event operator and/or his service provider. The record in the database should preferably also include the telephone number or wireless address of the virtual ticket device so that contact with the virtual ticket device may be established at a later time.

Entry point terminals are provided at the entrances of the public facility which read at least the encrypted authentication information from the virtual ticket device and authorize the customer to enter the event. The entry point terminals read the authentication information over a very short range wireless (RF) channel or infrared (IR) channel, or via a dedicated interface slot coupled to a wireline channel to prevent eavesdropping and spoofing of the process. For example, the virtual ticket device may be programmed to display the data either as a string of characters (e.g., serial number) or a bar code on its LCD display and the displayed information can be optically scanned in a chamber of the entry point terminal.

Preferably both the virtual ticket device and the arena or theater is also equipped with hardware and software which can track the location of the virtual ticket device in and around the facility with a precision of perhaps a few meters. Once the customer has purchased a virtual ticket, the virtual ticket device can be used, in conjunction with information stored in the database to provide a number of distinct information and marketing services to the customer.

Among these services is a messaging service that permits patrons of the public facility to enter personal messages on the virtual ticket devices. The personal messages are then displayed on one or more displays of the public facility. Accordingly, it is a primary object of the present invention to provide a messaging system for displaying personal messages on displays of a public facility. According to an advantageous embodiment of the present invention, the messaging system comprises: 1) a plurality of access points capable of communicating with a plurality of customer communication devices operated by customers of the public facility; 2) a personal message controller coupled to the plurality of access points and capable of receiving a first personal message from a first one of the customer communication devices; and 3) a display control system coupled to the personal message controller and capable of receiving from the personal message controller a first display control message associated with the first personal message, wherein the first control message is operable to cause the display control system to display the first personal message on at least one of the displays of the public facility.

According to one embodiment of the present invention, the personal message controller further receives from the first customer communication device display selection data selecting the at least one display for displaying the first personal message.

According to another embodiment of the present invention, the personal message controller transmits to the first customer communication device a list of selectable displays for displaying the first personal message.

According to still another embodiment of the present invention, the messaging system further comprises a location determination apparatus capable of determining a location of the first customer communication device in the public facility.

According to yet another embodiment of the present invention, the personal message controller determines the list of selectable displays based on the location of the first customer communication device.

According to a further embodiment of the present invention, the personal message controller further receives from the first customer communication device display time data selecting a time at which to display the first personal message.

According to a still further embodiment of the present invention, the personal message controller transmits to the first customer communication device a user interface application program operable to enable the first customer communication device to generate the first personal message and to transmit the first personal message to the personal message controller.

### BRIEF DESCRIPTION OF THE DRAWINGS

FIG. 1 is a plan diagram of a public facility in which an electronic ticket control system according to the principles of the present invention may be deployed;

FIG. 2 illustrates a virtual ticket device which is capable of interacting with an electronic ticket control system according to the principles of the present invention;

FIG. 3 illustrates a virtual electronic ticket displayed on the virtual ticket device in FIG. 2 according to one embodiment of the present invention;

FIG. 4 illustrates an electronic ticket control system according to one embodiment of the present invention;

FIG. 5 is a flow diagram illustrating the operation of the electronic ticket control system and the virtual ticket device according to one embodiment of the present invention;

FIG. 6 illustrates portions of the electronic ticket control system that permit patrons to display personal messages on displays of the exemplary public facility according to one embodiment of the present invention; and

FIG. 7 is a flow diagram illustrating the operation of receiving and displaying a personal message using the exemplary electronic ticket control system and the exemplary portable virtual ticket device according to one embodiment of the present invention.

### DETAILED DESCRIPTION OF THE INVENTION

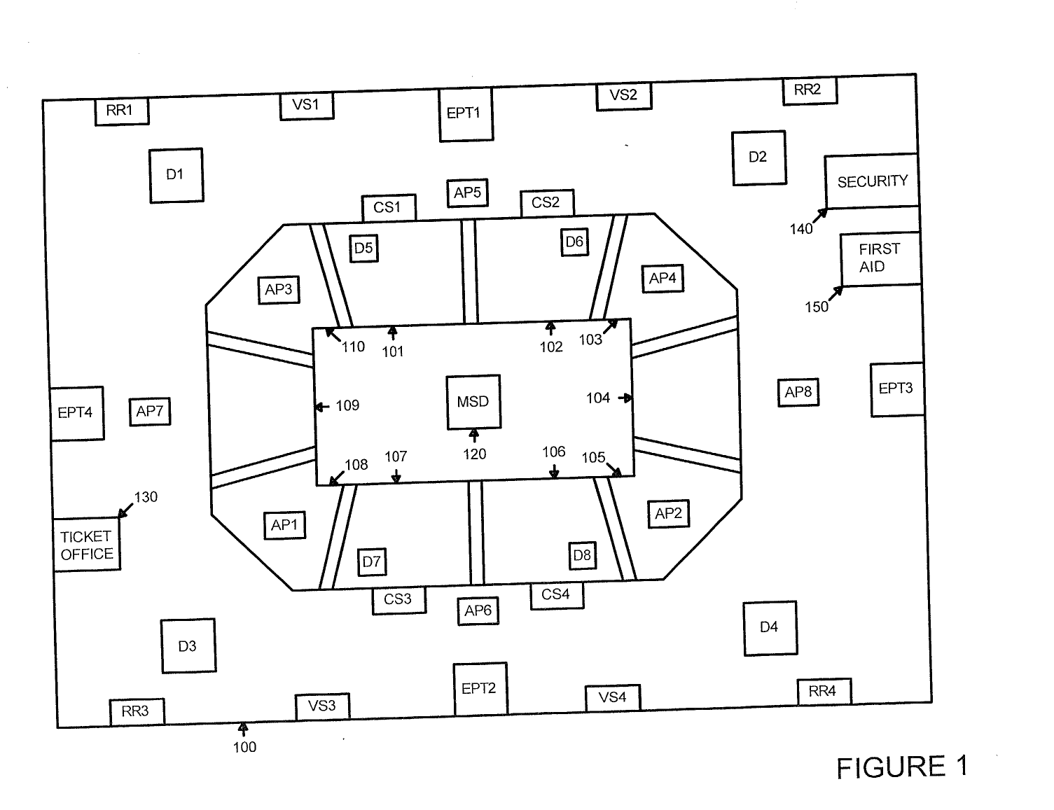

FIGS. 1 through 7, discussed below, and the various embodiments used to describe the principles of the present invention in this patent document are by way of illustration only and should not be construed in any way to limit the scope of the invention. Those skilled in the art will understand that the principles of the present invention may be implemented in any suitably arranged communications network capable of communicating with virtual ticket devices.

FIG. 1 is a plan view of public facility 100 in which an electronic ticket control system according to the principles of the present invention may be deployed. Public facility 100 is representative of any public venue that is capable of holding a large audience. Thus, public facility 100 may include a football or baseball stadium, a basketball or hockey arena, a large concert hall, a convention center, and the like. As used herein and for the purpose of determining the scope of the claims of the present invention, the term “public facility” may include any controlled-access location to which people may be admitted by means of an electronic ticket control system and should not be construed to exclude facilities that are privately owned or that are open only to selected portions of the general public. In fact, public facility 100 may include controlled-access private clubs and private buildings, and even controlled-access forms of transportation, such as trains, planes, cruise ships, and the like. However, for the purpose of simplicity in explaining the principles of the present invention, it shall be assumed that public facility 100 is a sports facility.

Public facility 100 comprises a plurality of seating areas, including exemplary seat sections 101-110, that surround a playing area (e.g, hockey rink, basketball court, indoor track, or the like). Suspended over the playing area is multi-sided display (MSD) 120, which has large display screens on four sides. The seating areas are surrounded by an exterior promenade area that contains a plurality of concession stands (CS), including four exemplary concession stands labeled CS1, CS2, CS3 and CS4. The promenade area also includes a number of rest rooms (RR), including exemplary rest rooms labeled RR1, RR2, RR3 and RR4, and numerous vendor shops (VS), including exemplary vendor shops labeled VS1, VS2, VS3 and VS4. Finally, the promenade area contains ticket office 130, security office 140, and first aid station 150.

Electronic displays of various types are positioned throughout public facility 100. In the promenade area, displays D1, D2, D3 and D4 enable patrons at the concession stands or vendor shops, or waiting in rest room lines, to view the sporting event that is ongoing in the playing area. In the seating area, patrons can view displays D5, D6, D7 and D8, which typically display advertisements, scores of other sporting events, player statistics, audience greetings, and the like. As used herein and for the purpose of determining the scope of the claims of the present invention, displays D1-D8 may be any type of conventional display devices, including electronic signs, conventional sized television sets, large screen television sets, and multisided television displays, that generally may be viewed by at least some of the customers of public facility 100 and do not include non-public displays which are viewed by employees of public facility 100.

For example, each one of displays D1, D2, D3 and D4 may be an elevated multisided display system having three or four sides, wherein each side contains a large screen video display. Also, in an exemplary embodiment, one or more of displays D5-D8 in the seating area may be a conventional television set that is disposed in a luxury box of public facility 100.

Each of entry point terminals EPT1, EPT2, EPT3 and EPT4 is disposed next to one of four entrances to public facility 100. EPT1, EPT2, EPT3 and EPT4 are capable of detecting and registering the virtual electronic tickets used by customers of public facility 100. EPT1-EPT4 read at least the encrypted authentication information from the virtual ticket device and authorize the customer to enter public facility 100. Each one of EPT1, EPT2, EPT3 and EPT4 registers the admission of each virtual electronic ticket by any one of several conventional technologies. For example, one or more of EPT1, EPT2, EPT3 and EPT4 may comprise an optical scanner that scans a bar code or a serial number displayed on the display of a virtual ticket device that stores each virtual electronic ticket. Alternatively, one or more of EPT1, EPT2, EPT3 and EPT4 may comprise a radio frequency transceiver that establishes an RF link (such as a Bluetooth connection), or an infrared (IR) transceiver that establishes an IR link, that transfers the virtual electronic ticket information from the virtual ticket device used by the customer to the entry point terminal. In still another embodiment, one or more of EPT1, EPT2, EPT3 and EPT4 may contain a slot or a similar hardware interface into which a virtual ticket device may be inserted or engaged in order to transfer the virtual electronic ticket information via a wireline connection.

Additionally, a number of wireless or wireline access points (APs) are distributed throughout the seating area and the promenade area of public facility 100. Exemplary access points labeled AP1-AP8 are shown in FIG. 1. According to an advantageous embodiment of the present invention, EPT1-EPT4 may function both as access points and as entry point terminals. AP1-AP8 provide communication channels that permit the virtual ticket devices used by customers to communicate with the electronic ticket control system associated with public facility 100. According to an advantageous embodiment of the present invention, AP1-AP8 are radio frequency transceivers of the base stations of a microcellular system that provide two-way radio frequency (RF) communication links with virtual ticket devices within public facility 100. Preferably, AP1-AP8 have a hand-off capability that allows a customer to roam throughout public facility 100 without losing communication with the electronic ticket control system. Advantageously, this allows the electronic ticket control system to continually track the location of each virtual ticket device in public facility 100.

However, in alternate embodiment of the present invention, one or more of AP1-AP8 may be physical interface slots into which virtual tickets devices may be inserted. For example, each seat in public facility 100 may be provided with an interface slot (similar to an electronic cradle) that may mate with a virtual ticket device. A wireline connection to each such interface slot enables each virtual ticket device to communicate with the electronic ticket control system. Furthermore, according to an advantageous embodiment of the present invention, exterior access points may be disposed in the areas outside of public facility 100 in order to communicate with customers as they are nearing, and before they enter public facility 100.

Access points, such as AP1-AP8 and EPT1-EPT4, may be used to provide a variety of user-friendly services to the patrons of public facility 100. When a customer is near, but not yet admitted to, public facility 100, the access points may transmit useful information to the virtual ticket device used by the customer, including directions to the nearest entrance, advice as to which entrance has the shortest waiting line, promotional items available at vendor shops and concession stands, and the like. After the customer has been admitted to public facility 100, the access points may provide the virtual ticket device real time directions from her present location to her assigned seat, to particular concession stands or vendor shops, to rest rooms, or to other service areas. Information on which concession and service has the shortest line can also be provided.

Using the access points, the facility operator can know in real time how many admitted customers are at their seats and may schedule the start of programs on this basis. The customer can place orders for food and promotional items via the access points using the virtual ticket device and the vendors can deliver these goods to her present location. The access points and the virtual ticket device can also be used to authenticate the identity of the customer before the goods are turned over to her.

The facility operator may use the access points to communicate information to the virtual ticket devices about available seating upgrades. These could be based on the real time location of the customer. For example, an access point may transmit to the virtual to ticket device the message: “Two seats are available in the section in front of you. Would you like to move there for an additional $10?” If the virtual ticket device has capability for broadband communication and a reasonably high quality display, this could be supplemented with video promotions, such as: “Here's what the last home run looked like from section 110. Would you like to upgrade your seat and move there?”

Customers can use their virtual ticket devices to signal their present location within public facility 100 to friends and to locate lost family members. A network of entry point terminals may 20 be used within public facility 100 to authorize admission to various areas such as preferred seating sections, clubs, luxury boxes, reserved rest rooms, priority parking lots, and the like. Additionally, automated cameras in public facility 100 may be used to photograph the customers during an event and the photographs can later be identified with groups of virtual tickets and offered for sale to the customers. In the case of accidents or disruptions, the location information can be used to contact potential witnesses. Additionally, seating and purchase information can be used for directed post-event marketing, which can be communicated directly to the virtual ticket device.

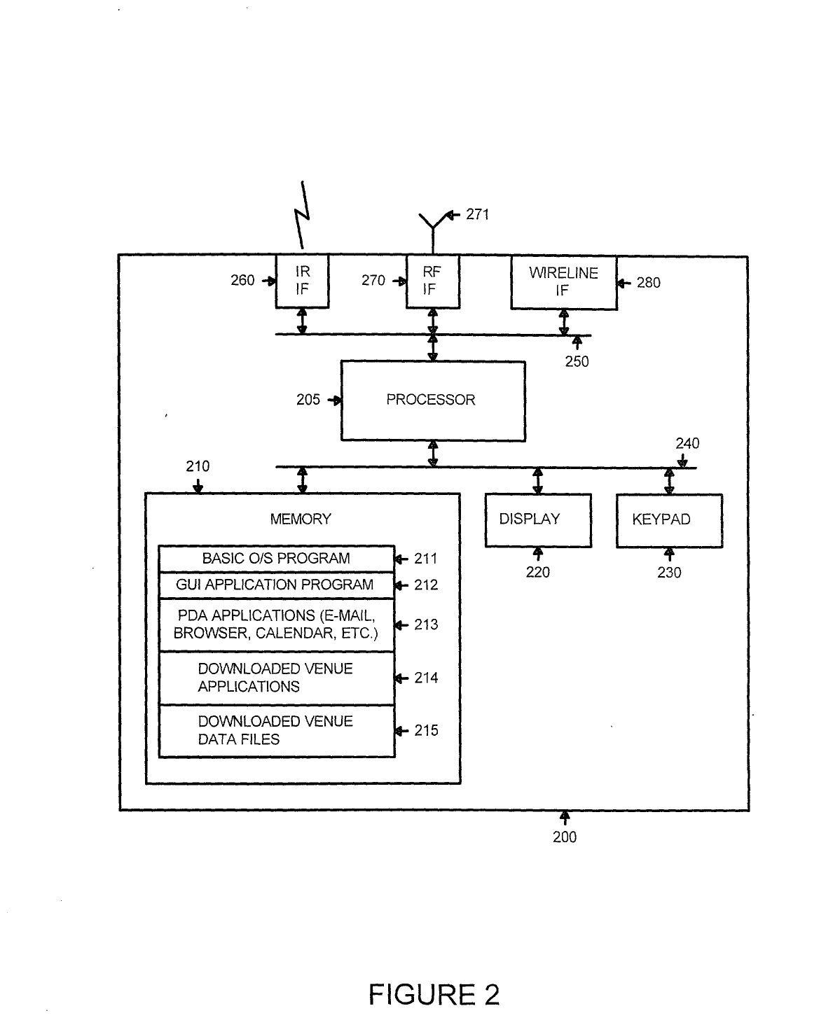

FIG. 2 illustrates virtual ticket device 200, which is capable of interacting with an electronic ticket control system according to the principles of the present invention. Virtual ticket device 200 comprises processor 205, memory 210, display 220, keypad 230, and one or more communication interfaces, including infrared (IR) interface (IF) 260, radio frequency (RF) interface (IF) 270, and wireline interface (IF) 280. Processor 205, memory 210, display 220, and keypad 230 are coupled to, and communicate via, system bus 240. Processor 205, memory 210, display 220, and keypad 230 are coupled to, and communicate via, input/output (I/O) bus 250.

Processor 205 controls the overall operation of virtual ticket device 200 by executing basic operating system (O/S) program 211 in memory 210. Memory 210 also stores graphical user interface (GUI) application program 212, a plurality of personal digital assistant (PDA) applications 213, downloaded venue applications 214, and downloaded venue data files 215. PDA applications 213 may include, for example, an e-mail application, a browser application, a calendar application, and the like.

In the illustrated embodiment, virtual ticket device 200 contains three external communication interfaces, namely, infrared interface 260, radio frequency interface 270, and wireline interface 280. However, not all of these external communication interfaces are necessary to the operation of the invention. For example, in an advantageous embodiment of the present invention, virtual ticket device 200 may only contain wireline interface 280 and RF interface 270. Virtual ticket device 200 may be adapted for insertion into a cradle device that plugs into wireline interface 280 and provides virtual ticket device 200 with electrical power for recharging a battery (not shown) in virtual ticket device 200. When virtual ticket device 200 is plugged into a cradle device, applications and data may be downloaded or uploaded via wireline interface 280.

For example, in an advantageous embodiment of the present invention, virtual ticket device 200 may be a wireless enabled electronic organizer, such as a Palm VII™ organizer. As those skilled in the art are aware, a Palm VII™ organizer (or an equivalent appliance) is capable of communicating via a wireless interface (such as RF interface 270) and may be mounted in a cradle device that provides wireline communication and power supply voltages to the organizer.

Processor 205 executes GUI application program 212 in order to interact with the operator of virtual ticket device 200 via keypad 230 and display 220. Normally, GUI application program 212 enables processor 205 to execute PDA applications 213 stored in memory 210. One of these applications may include a browser application that allows virtual ticket device 200 to access via RF interface 270 or wireline interface 280 a website for a ticket agency in order to purchase a virtual electronic ticket to an event at public facility 100. When a virtual electronic ticket is purchased in this manner, the virtual electronic ticket and other useful applications and data files may be downloaded from the ticket agency website to virtual ticket device 200 and stored in downloaded venue applications 214 and downloaded venue data file 215.

Downloaded venue data file 215 may be used to store such information as the virtual electronic ticket, electronic maps of public facility 100, text information related to concession stands and vendor shops, and text information related to security and first aid at public facility 100. Downloaded venue applications 214 may include one or more applications executed by processor 205 when the customer is at public facility 100. In particular, downloaded venue applications 214 may include a communication application that enables processor 205 to control the operation of RF interface 270 and wireline interface 280 such that virtual ticket device 200 is capable of communicating with access points AP1-AP8 and entry point terminals EPT1-EPT4 at public facility 100. For example, the communication application may configure RF interface 270 in virtual ticket device 200 to use the operating frequency channels and medium access control (MAC) layer protocols used by AP1-AP8 and EPT1-EPT4.

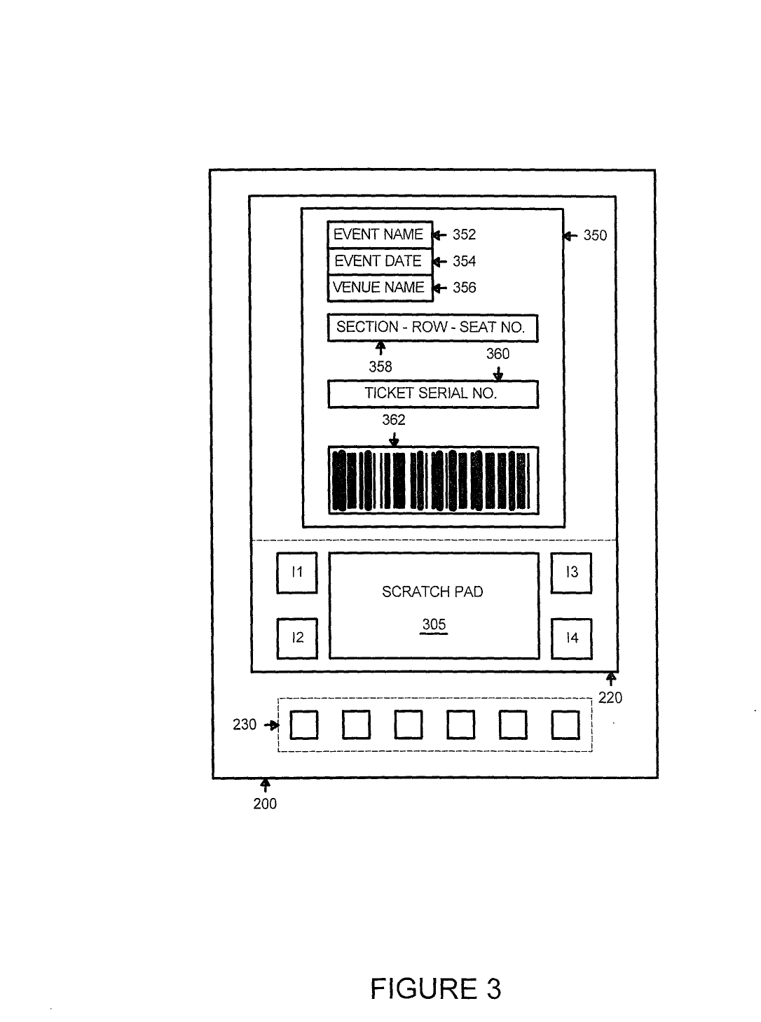

FIG. 3 illustrates virtual electronic ticket 350 displayed on virtual ticket device 200 according to one embodiment of the present invention. Virtual ticket device 200 comprises display 220, and keypad 230. The lower portion of display 220 contains scratch pad 305 and a plurality of icons, namely icons I1, I2, I3, and I4. The upper portion of display 220 contains virtual electronic ticket 350. Virtual electronic ticket 350 comprises event name field 352, event date field 354, venue name field 356, seating information field 358, ticket serial number field 360, and bar code field 362.

The operator of virtual ticket device 200 may use a stylus or a similar device to select icons I1, I2, I3 or I4 and thereby launch one or more of PDA applications 213 in memory 210. Additionally, the operator may use the stylus to enter text or numbers in scratch pad area 305 when executing one of PDA applications 213 that permits the entry of text data. Additionally, the buttons in keypad 230 may be used to select icons or to perform functions such as scroll up, scroll down, scroll left, scroll right and the like.

When the customer approaches or enters public facility 100, the customer turns on virtual ticket device 200 and launches the communication application in downloaded venue applications 214 that allows virtual ticket device 200 to communicate with entry point terminals EPT1-EPT4 and access points AP1-AP8 in public facility 100. The communication application may be launched automatically simply by selecting virtual electronic ticket 350 that has been downloaded and stored in downloaded venue data files 215. Event name field 352 contains the name of the event occurring in public facility 100, such as “New York Knicks vs. Indiana Pacers.” Event date field 354 contains the date on which the event is occurring, such as “Nov. 13, 2001.” Venue name field 356 contains the name of public facility 100, such as “Madison Square Garden.” Seating information field 358 contains the section, row and seat number information associated with virtual electronic ticket 350.

If the entry point terminal contain an optical scanner, the optical scanner may scan one or both of ticket serial number field 360 and bar code field 362. An optical character recognition application may be used to read the serial number appearing in ticket serial number field 360. A conventional bar code scanner device may read the bar code in bar code field 362. In either event, when virtual electronic ticket 350 is identified, the entry point terminal accesses the data base associated with the electronic ticket control system associated with public facility 100 and, if virtual electronic ticket 350 is properly authenticated, permits the customer to enter public facility 100. The entry point terminal may produce a visible or audible signal approving entry by the customer. Alternatively, if virtual electronic ticket 350 is not authenticated, the entry point terminal may generate an audible or visual alarm alerting a nearby gate attendant that the customer should not be admitted to public facility 100.

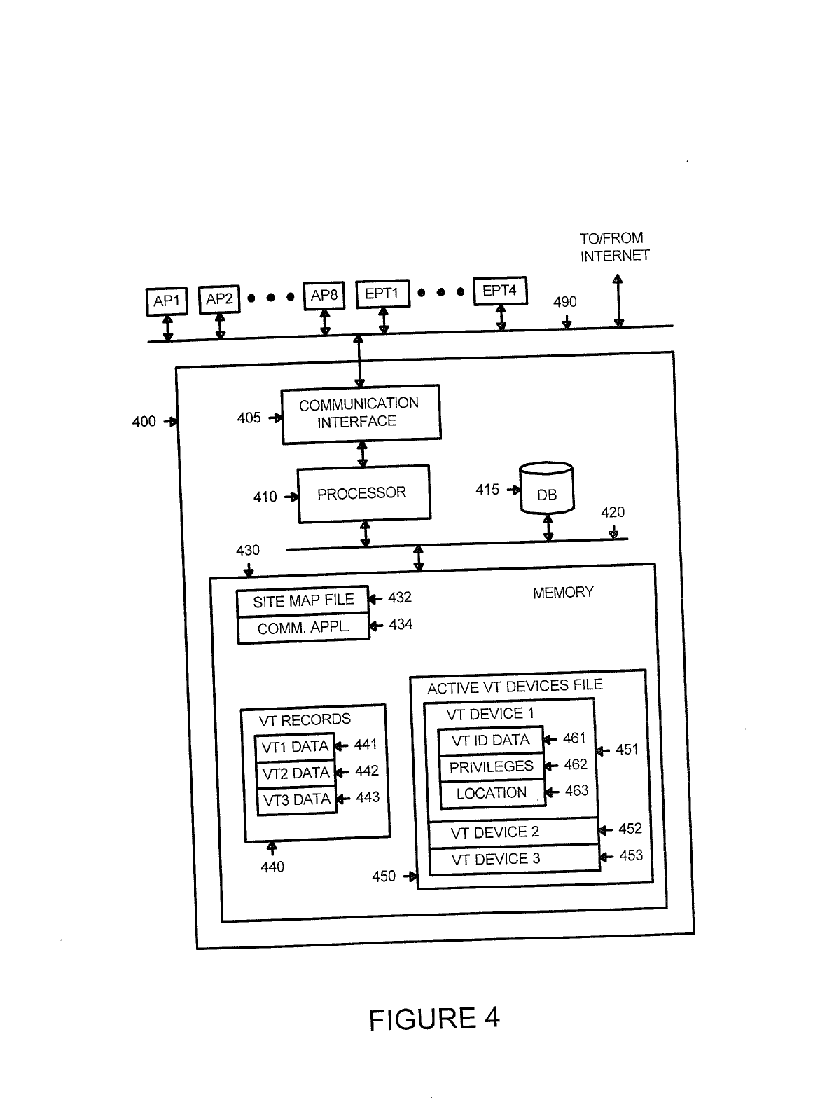

FIG. 4 illustrates electronic ticket control system 400 according to one embodiment of the present invention. Electronic ticket control system 400 comprises communication interface 405, processor 410, database (DB) 415, and memory 430. Processor 410, database (DB) 415, and memory 430 are coupled to, and communicate via system bus 420. Communication interface 405 has an external network connection that interfaces with network bus 490. Communication interface 405 enables processor 410 to communicate with exemplary access points AP1-AP8 and exemplary entry point terminals EPT1-EPT4. Communication interface 405 also enables processor 410 to communicate with remote servers and other devices via the Internet.

Memory 430 stores site map file 432, communication application program 434, virtual ticket records 440, and active virtual ticket devices file 450. Virtual ticket records 440 contains a plurality of virtual ticket data records 441-443, which are arbitrarily labeled VT1 DATA, VT2 DATA and VT3 DATA, respectively. Virtual ticket records 440 comprises a master list of all virtual tickets that were sold to the particular event occurring at public facility 100. Each virtual ticket data record 441-443 contains the serial number or bar code of each virtual ticket, the section and seat number information associated with each virtual ticket, payment information (optionally), the privileges associated with each virtual ticket, and the like. The virtual tickets that are received from the virtual ticket devices are compared to the virtual ticket data in virtual ticket records 440 before admitting each customer to public facility 100.

Virtual ticket data records 441-443 may be downloaded via the Internet from a server associated with a ticketing agency that sells tickets to events held at public facility 100. Alternatively, electronic ticket control system 400 itself also may function as a server that potential customers may access over the Internet in order to buy virtual tickets. As each virtual ticket is sold to a potential customer, electronic ticket control system 400 creates and stores a corresponding virtual ticket data record 441 and transmits the electronic virtual ticket over the Internet to the customer.

Active virtual ticket devices file 450 contains virtual ticket device records 451-453 associated with virtual ticket devices that are in active communication with electronic ticket control system 400. After each received virtual ticket is received and authenticated, a virtual ticket device record for the corresponding virtual ticket device that has been admitted is created in active virtual ticket device file 450. Virtual ticket device records 451-453 are arbitrarily labeled VT DEVICE 1, VT DEVICE 2, and VT DEVICE 3, respectively. Exemplary virtual ticket device record 451 comprises virtual ticket (VT) identification (ID) data field 461, privileges field 462, and location field 463. Database 415 normally holds the master copies of all of the information stored in memory 430. However, the information in database 415 is loaded into memory 430 for processing by processor 410.

Site map file 432 contains electronic map data that may be downloads to virtual ticket device 200 in order to display the location of the seat corresponding to a particular virtual ticket. The electronic map data also may illustrate the locations of the rest rooms, concession stands, vendor shops, ticket office 130, security office 140 and first aid station 150. Virtual ticket identification field 461 identifies the virtual ticket associated with virtual ticket device record 451. Privileges field 462 indicates the restricted areas in public facility 100 to which the virtual ticket gains admission. For example, privileges field 462 may indicate which restaurants and luxury boxes the user of a particular virtual ticket may enter. Finally, location field 463 indicates the current location of virtual ticket device 200.

Communication application program 434 comprises a communication protocol that may be transmitted to virtual ticket device 200 in order to permit virtual ticket device 200 to communicate with the access points and entry point terminals in public facility 100. According to one embodiment of the present invention, a user of virtual ticket device 200 may download communication application program 434 from electronic ticket control system 400 via the Internet before going to public facility 200. Alternatively, electronic ticket control system 400 may initially use a standard protocol to establish a simple connection with virtual ticket device 200 and then may download communication application 434 is order to establish a more advanced communication link.

For example, if EPT1 and virtual ticket device 200 are both Bluetooth-enabled systems, EPT1 may establish an initial Bluetooth connection with virtual ticket device 200 as the user of virtual ticket device 200 approaches EPT1. After the Bluetooth connection is established, EPT1 may download communication application program 434 to virtual ticket device 200. Thereafter, virtual ticket device 200 may use communication application program 434 to establish wireless LAN (e.g., IEEE 802.11) connections with one or more of EPT1-EPT4 and AP1-AP8 as the user of virtual ticket device 200 roams around public facility 100.

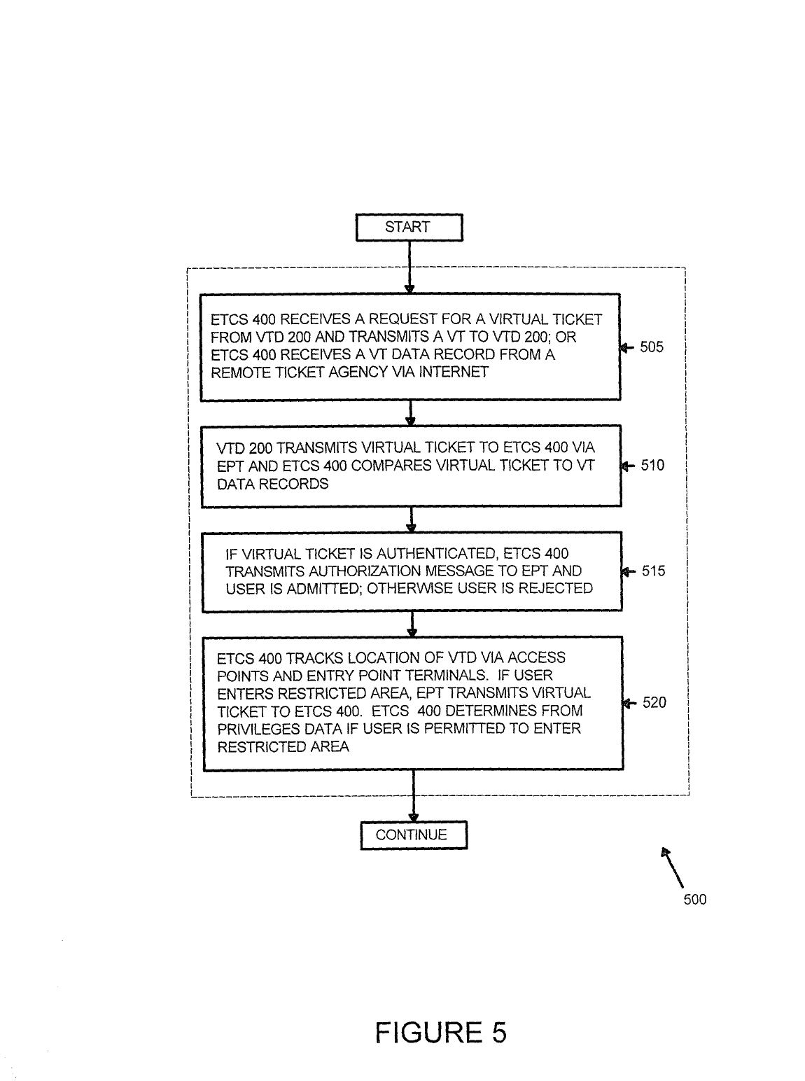

FIG. 5 depicts flow diagram 500, which illustrates the operation of electronic ticket control system 400 and portable virtual ticket device 200 according to one embodiment of the present invention. Initially, electronic ticket control system 400 receives a request for a virtual ticket from virtual ticket device 200. This request may be received via the Internet or via a telephone connection. In response, electronic ticket control system 400 transmits a virtual ticket to virtual ticket device 200. Alternatively, electronic ticket control system 400 may receive a virtual ticket data record for an already issued ticket from a remote ticket agency via the Internet (process step 505).

When the user finally arrives at public facility 100 to attend the event, virtual ticket device 200 transmits the virtual ticket stored in the virtual ticket device 200 to electronic ticket control system 400 via an entry point terminal. Electronic ticket control system 400 then compares the virtual ticket to the virtual ticket data records 440 stored in memory 430 or database 415 (process step 510). If the virtual ticket is authenticated, electronic ticket control system 400 transmits an authorization message to the entry point terminal and the user is admitted. Otherwise, the user is rejected (process step 515).

During the event, electronic ticket control system 400 may track the location of virtual ticket device 200 via the numerous access points and entry point terminals. If the user attempts to enter a restricted area, such as a private restaurant, a luxury box, or a premium seating area, the entry point terminal at the restricted area transmits the virtual ticket to electronic ticket control system 400. Electronic ticket control system 400 determines from the privileges data whether or not the user is permitted to enter the restricted area (process step 520).

In an advantageous embodiment of the present invention, customers may use virtual ticket devices to send personal messages to electronic ticket control system 400 for subsequent display on one or more of the displays, D1-D8, in public facility 100. The personal messages may be simple text messages, such as “Happy Birthday, Michael!”, “Nicole, will you marry me?”, or the like. The personal messages may also include graphical images provided by the user of virtual ticket device 200. This may be performed as a free service available to any patron using virtual ticket device 200. Alternatively, electronic ticket control system 400 may enhance the revenue of the operator of public facility 100 by charging a fee for such a service.

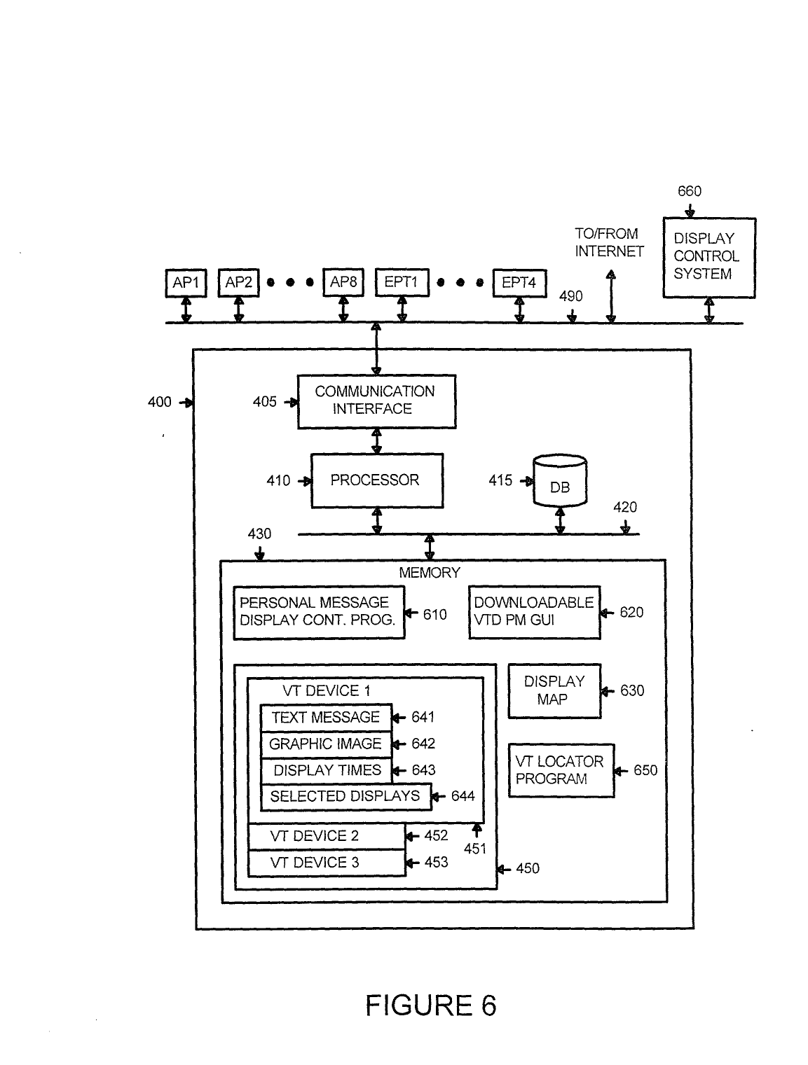

FIG. 6 illustrates portions of electronic ticket control system 400 that permit patrons to display personal messages on displays of public facility 100 according to one embodiment of the present invention. In addition to the components illustrated and described above in FIG. 4, electronic ticket control system 400 also comprises a plurality of application programs and data files stored in memory 430 that enable electronic ticket control system 400 to communicate with virtual ticket devices in order to receive and display personal messages for subsequent display on displays D1-D8 of public facility 100. Memory 430 stores personal message display control program 610, downloadable virtual ticket device (VTD) personal message (PM) graphical user interface (GUI) program 620, display map 630, and virtual ticket device locator program 650. Also, VT device record 451 in virtual device file 450 also contains text message data field 641, graphic image data field 642, display times data field 643, and selected displays data field 644.

Personal message display control program 610 contains program instructions that are executed by processor 410 to enable electronic ticket control system 400 to communicate with virtual ticket devices in order to receive personal messages and to transmit the personal messages to display control system 600 for subsequent display on displays D1-D8 of public facility 100. Display control system 600 may be any type of conventional control system that is able to receive external commands and generate corresponding display messages for display on selected ones of displays D1-D8. No particular architecture is intended for display control system 600 and further discussion of display control system 600 is beyond the scope of the present disclosure.

It was noted in the above description of FIG. 2 that downloaded venue applications 214 in virtual ticket device 200 may include one or more applications executed by virtual ticket device 200 when the customer is at public facility 100. These applications may be downloaded before the customer arrives at public facility 100 (e.g., via the Internet) or may be downloaded at public facility 100 via entry point terminals EPT1-EPT4 or access points AP1-AP8. Downloadable VTD personal message GUI program 620 is one such downloadable program. VTD personal message GUI program 620 provides a graphical user interface in virtual ticket device 200 which enables the user to interact with personal message display control program 610. According to an exemplary embodiment of the present invention, the graphical user interface of VTD personal message GUI program 620 may be a similar to an e-mail application or a two-way paging application. VTD personal message GUI program 620 prompts the user to enter a personal message, displays one or more selectable displays on which to display the entered personal message, and permits the user to enter the number of times to display the personal message and the times at which to display the personal message.

The personal message entered by the user of virtual ticket device 200 is transmitted to electronic ticket control system 400 and stored in text message data field 641. If the user has previously stored a graphic image file, such as a JPEG file, in virtual ticket device 200, the graphic image file may be appended to the transmitted personal message and stored in graphic image data field 642. The user-selected display times are stored in display times data field 643 and the user-selected displays are stored in selected displays data field 644. Processor 410, under control of personal message display control program 610 uses the data values stored in text message data field 641, graphic image data field 642, display times data field 643, and selected displays data field 644 to format commands and data that are sent to display control system 660 in order to display the personal message.

According to an advantageous embodiment of the present invention, the user of virtual ticket device 200 may select only certain ones of displays D1-D8 to display the personal message. The selected displays may be determined according to the location of virtual ticket device 200. Personal message display control program 610 may use virtual ticket device locator program 650 to determine the location of virtual ticket device 200. Generally, the location of virtual ticket device 200 may be determined from the section and seat information associated with the virtual ticket of the user. However, assuming the user roams around, the location of virtual ticket device 200 may be determined by transmitting a mes sage to virtual ticket device 200 prompting the user to enter his or her current location (i.e., nearby section and seat values). In still another embodiment of the present invention, virtual ticket device locator program 650 may determine the location of virtual ticket device 200 according to the location of the access point that is in communication with the virtual ticket device. In particular, in more advanced RF systems, virtual ticket device locator program 650 may use microcell, signal strength, phase or triangulation information captured by two or more access points to determine the location of virtual ticket device 200 without requiring any user input.

Once the location of virtual ticket device 200 is determined, personal message display control program 610 may use the information in display map file 630 to identify one or more displays that are visible to the user at his or her location. The identified displays are transmitted to virtual ticket device 200 for selection by the user of virtual ticket device 200.

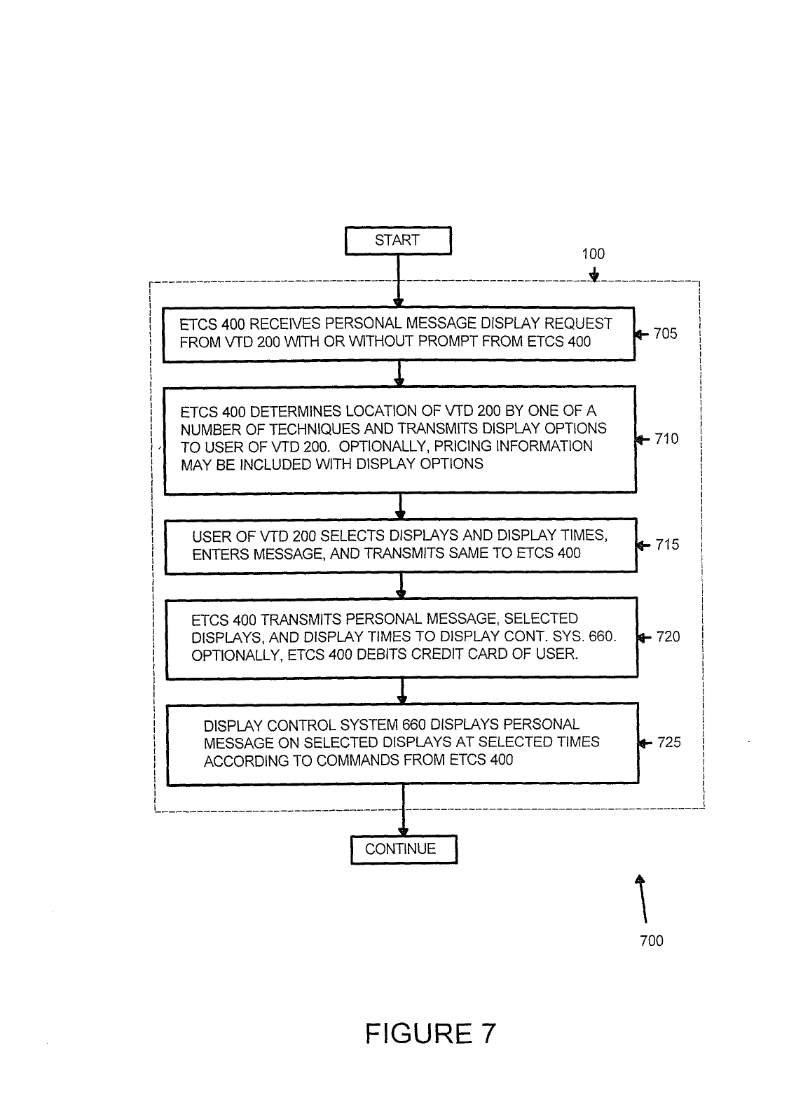

FIG. 7 depicts flow diagram 700, which illustrates the operation of receiving and displaying a personal message using electronic ticket control system 400 and portable virtual ticket device 200 according to one embodiment of the present invention. Initially, electronic ticket control system 400 receives a personal message display request from virtual ticket device 200. This personal message display request may be entered spontaneously by the user or may be entered in response to a prior prompt message from electronic ticket control system 400 (process step 705). Next, electronic ticket control system 400 determines the location of the virtual ticket device 200 by any one of the techniques described above and transmits display options to the user of virtual ticket device 200. Optionally, pricing information may be included with display options (process step 710). The operator of public facility 100 may charge a higher fee to a customer according to how many displays the customer selects, the size and location of the selected display(s), the number of times the personal message is to be displayed, the duration of the personal message, the size of the personal message, and whether or not a graphic image is part of the personal message.

Next, the customer uses virtual ticket device 200 to select one or more displays and the corresponding display times. The customer also enters his or her personal message and transmits all of the entered information to electronic ticket control system 400 (process step 715). Electronic ticket control system 400 then transmits the personal message, the selected displays, and the display times to display control system 660. If the personal message service is not free, electronic ticket control system 400 may debit the credit card of the user of virtual ticket device 200 to pay for the personal message (process step 720). Finally, display control system 660 displays the personal message on the selected displays at the selected times according to commands received from electronic ticket control system 400 (process step 725).

What is claimed is:

1. A method of doing business comprising downloading to a customer communication device a user interface program which enables a customer to use the device to display personal messages to members of the audience at a public facility.

2. The method of claims 1 wherein the application program enables customer to use the device to specify textual and/or graphical content of the message and selected locations within the facility where the message will be displayed.

3. The method of claim 1 wherein the application program further enables the customer to authorize payment of a fee for displaying the message.

4. The method of claim 3 wherein the application program determines the amount of the authorized fee in dependence on the content of the message.

5. A method of doing business comprising:
soliciting customers to display private messages to members of the audience at public facilities by providing access points for connection to customer communication devices within the facility;
receiving personal messages data which customers enter via customer communication devices connected to access points;
displaying the message specified by the received messages data to the audience on one or more selected displays; and charging a fee to the customers for displaying the messages.

6. The method of claim 5 wherein the message data includes the content of the message, the location or locations where the message is to be displayed, and authorization to charge the fee to the customer's account.

7. The method of claim 6 wherein the message data further includes a specification of the time or times the message is to be displayed.

8. The method of claim 5 wherein the fee is determined in part by the content of the message.

9. The method of claim 5 wherein the fee is determined in part by the location or locations where the message is to be displayed.

10. The method of claim 5 wherein the fee is determined in part by the time or times the message is to be displayed.

11. A messaging system for displaying personal messages from customers to members of the audience at a public facility, comprising:
one or more access points which are connectable to communicate with a plurality of customer communication devices operated by customers of the public facility;
a personal message controller coupled to the access points for reception of personal messages from the customer communications devices;
one or more message display devices positioned at locations in the facility where they are viewable by members of the audience; and
a message display controller which receives message signals from the personal message controller transmits messages to selected at least one or the display devices for display thereon.

12. The system of claim 11 wherein the access points comprise means for wireless connection to the customer communication devices.

13. The system of claim 12 wherein the access points comprise a microcellular communication system.

14. The system of claim 11 further comprising means which determine the location within the facility of customer communication devices which are connected to the system.

15. The system of claim 11 or 14 wherein the personal message controller transmits to each connected customer communication device a list of potential locations for displaying a personal message.

16. The system of claim 15 wherein the personal message controller generates each list on the basis of the determined location of the relevant connected customer communication device.

17. The system of claim 16 wherein the personal message controller transmits to each connected customer communication device a downloadable user interface application program which is capable of enabling the customer communication device to generate a personal message and transmit the personal message to the personal message controller.

18. The system of claim 17 wherein the interface application program is further capable of transmitting payment authorization information from the customer communication device to the system.

19. A messaging system for displaying personal messages on displays of a public facility, said messaging system comprising:
a plurality of access points capable of communicating with a plurality of customer communication devices operated by customers of said public facility;
a personal message controller coupled to said plurality of access points and capable of receiving a first personal message from a first one of said customer communication devices; and
a display control system coupled to said personal message controller and capable of receiving from said personal message controller a first display control message associated with said first personal message, wherein said first control message is operable to cause said display control system to display said first personal message on at least one of said displays of said public facility.

20. The messaging system as set forth in claim 19 wherein said personal message controller further receives from said first customer communication device display selection data selecting said at least one display for displaying said first personal message.

21. The messaging system as set forth in claim 20 wherein said personal message controller transmits to said first customer communication device a list of selectable displays for displaying said first personal message.

22. The messaging system as set forth in claim 21 further comprising a location determination apparatus capable of determining a location of said first customer communication device in said public facility.

23. The messaging system as set forth in claim 22 wherein said personal message controller determines said list of selectable displays based on said location of said first customer communication device.

24. The messaging system as set forth in claim 19 wherein said personal message controller further receives from said first customer communication device display time data selecting a time at which to display said first personal message.

25. The messaging system as set forth in claim 19 wherein said personal message controller transmits to said first customer communication device a user interface application program operable to enable said first customer communication device to generate said first personal message and to transmit said first personal message to said personal message controller.

26. A method of operating a messaging system for displaying personal messages on displays of a public facility, the method comprising the steps of:
establishing a plurality of communication links with a plurality of customer communication devices operated by customers of the public facility;
receiving a first personal message from a first one of the customer communication devices; and
displaying at the first personal message on at least one of the displays of the public facility.

27. The method as set forth in claim 26 further comprising the step of receiving from the first customer communication device display selection data selecting the at least one display for displaying the first personal message.

28. The method as set forth in claim 27 further comprising the step of transmitting to the first customer communication device a list of selectable displays for displaying the first personal message.

29. The method as set forth in claim 28 further comprising the step of determining a location of the first customer communication device in the public facility.

30. The method as set forth in claim 29 further comprising the step of determining the list of selectable displays based on the location of the first customer communication device.

31. The method as set forth in claim 26 further comprising the step of receiving from the first customer communication device display time data selecting a time at which to display the first personal message.

32. The method as set forth in claim 26 further comprising the step of transmitting to the first customer communication device a user interface application program operable to enable the first customer communication device to generate the first personal message and to transmit the first personal message to the messaging system.

33. A method of operating a communication device capable of displaying personal messages on selected displays of a public facility, the method comprising the steps of:
establishing a communication link with a messaging system of the public facility via an access point;
receiving text data comprising the first personal message entered by a user of the communication device;
receiving display selection data entered by the user of the communication device selecting at least one display for displaying the first personal message; and
transmitting the text data and the display selection data to the messaging system.

34. The method as set forth in claim 33 further comprising the step of receiving from the messaging system a list of selectable displays for displaying the first personal message.

35. The method as set forth in claim 33 further comprising the step of receiving display time data entered by the user of the communication device selecting a time at which to display the first personal message.

36. The method as set forth in claim 33 further comprising the step of receiving from the messaging system a user interface application program operable to enable the communication device to generate the first personal message and to transmit the first personal message to the messaging system.

37. A communication device capable of displaying personal messages on selected displays of a public facility, the communication device comprising:
a keypad capable of receiving text data entered by a user of said communication device;
a communication controller capable of establishing a communication link to a messaging system via an access point associated with said public facility;
a personal message controller capable of receiving said entered text data and generating therefrom a first personal message, wherein said personal message controller causes said communication controller to transmit said first personal message to messaging system.

38. The communication device as set forth in claim 37 wherein said personal message controller is further capable of receiving display selection data entered on said keyboard selecting said at least one display for displaying said first personal message.

39. The communication device as set forth in claim 38 wherein said personal message controller receives from said messaging system a list of selectable displays for displaying said first personal message and wherein said personal message controller displays said list on a display of said communication device.

40. The communication device as set forth in claim 37 wherein said personal message controller is further capable of receiving display time data entered on said keyboard selecting a time at which to display said first personal message.
